(19) United States
(12) Patent Application Publication
(10) Pub. No.: US 2007/0034174 A1
(43) Pub. Date: Feb. 15, 2007

(54) Horizontal heat dispensing fins of cylinder body

(76) Inventor: Chang Chi Lee, Fengyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/199,080

(22) Filed: Aug. 9, 2005

(51) Int. Cl. F02F 1/06

(52) U.S. Cl. 123/41.69

(57) ABSTRACT

A heat dispensing device for a cylinder includes a plurality of fins extending from the cylinder body and each fin has a first end horizontally extending from an outer surface of the cylinder body and a second end of each of the fins has a fork-shaped distal end which includes two protrusions in axial direction so as to increase the area for dispensing heat. There are gaps defined between fins such that airflow may pass through the gaps between the fins to bring heat from the cylinder body.

### FIELD OF THE INVENTION

The present invention relates to a heat dispensing device on a cylinder body and the device includes a plurality of horizontal fins and each fins includes a Y-shaped distal end.

### BACKGROUND OF THE INVENTION

A conventional cylinder is shown in FIG. 5 and generally includes a cylinder body 11 with a heat dispensing device 12 connected thereto. The cylinder body 11 has an inlet (not shown) and an outlet 110. The heat dispensing device 12 includes a plurality of plate type fins 121 which extending transversely (horizontally) and perpendicularly from the body 11 and are parallel with each other. However, the fins 121 are in a form of straight plate and parallel with each other, so that limited number of the fins 121 are allowed to be connected to the cylinder body 11 so that the efficiency of heat dispense is restricted. Besides, the area of the fins 121 is limited because all the fins 121 extend from a limited area on the cylinder body 11.

The present invention intends to provide a heat dispensing device composed of a plurality of horizontal fins extending from an outer surface of a cylinder body and each fin has a fork-shaped distal end so that the heat dispensing area is larger than the conventional fins.

### SUMMARY OF THE INVENTION

The present invention relates to a heat dispensing device for a cylinder and the device includes a plurality of horizontal fins wherein each fin has a first end transversely extending from an outer surface of the cylinder body and a second end of each of the fins has a fork-shaped distal end.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the heat dispensing device of the present invention on a cylinder body;

FIG. 2 is a side view to show the cylinder body and the heat dispensing device of the present invention;

FIG. 3 shows that each fin includes a fork-shaped distal end;

FIG. 4 shows airflow passes through gaps between the fins, and

FIG. 5 is a perspective view to show a conventional heat dispensing device on a cylinder body.

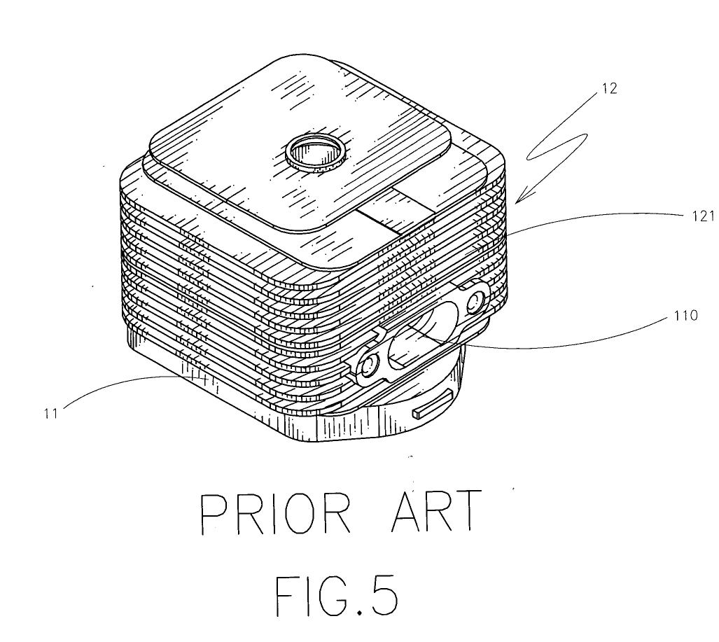

### DETAILED DESCRIPTION OF THE PREFERRED EMBODIMENT

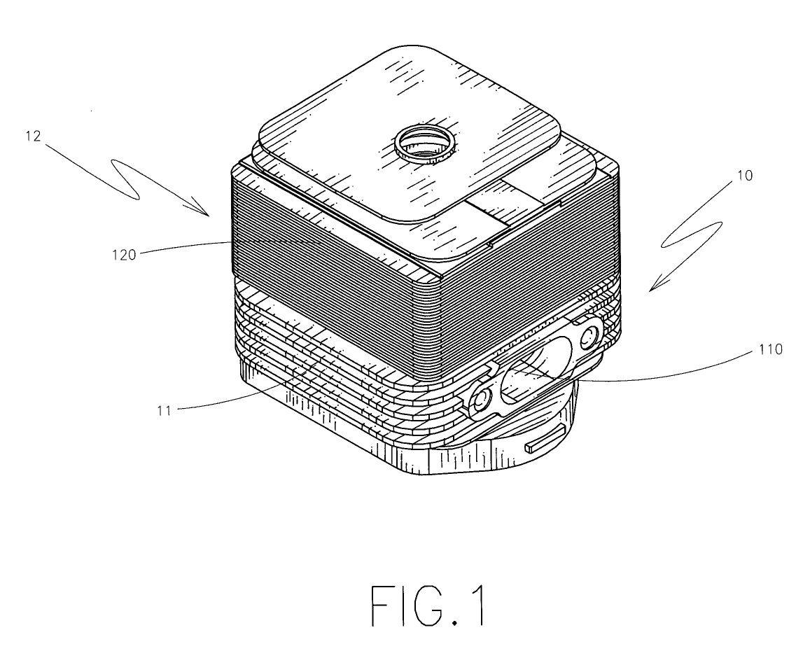

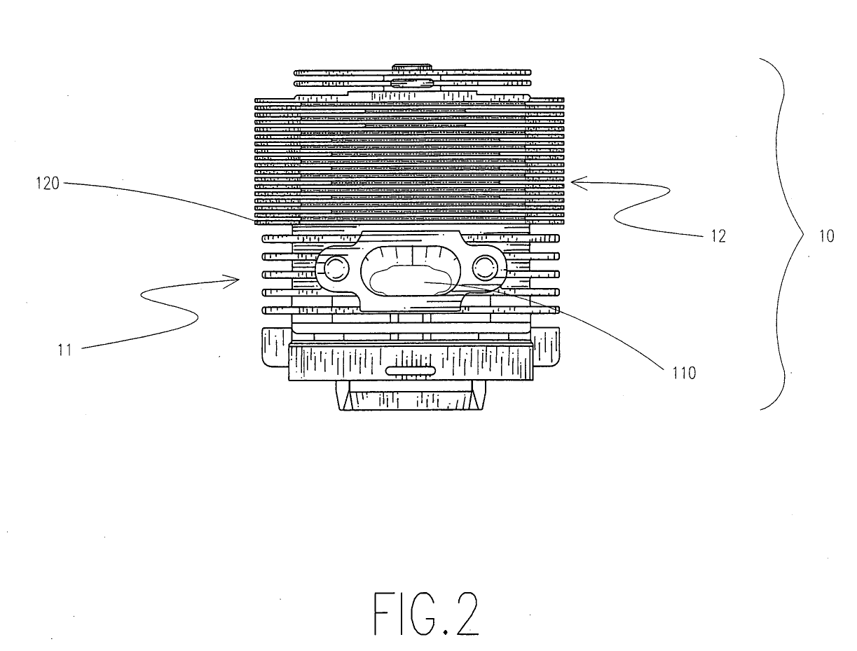

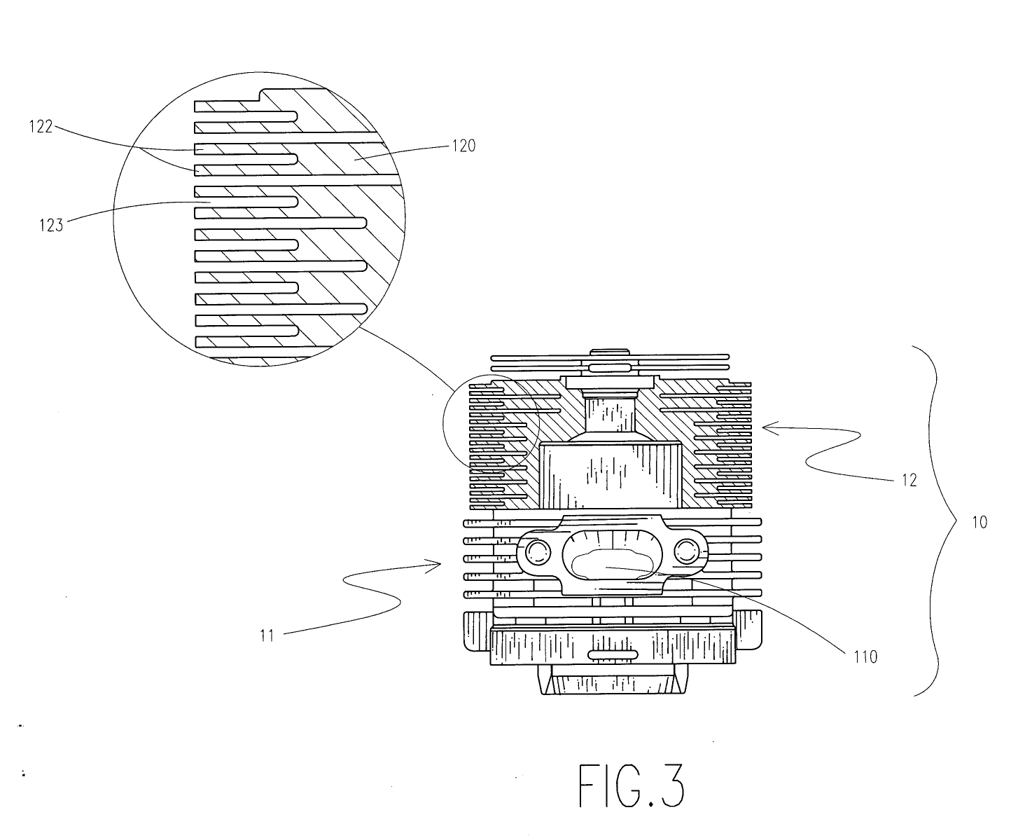

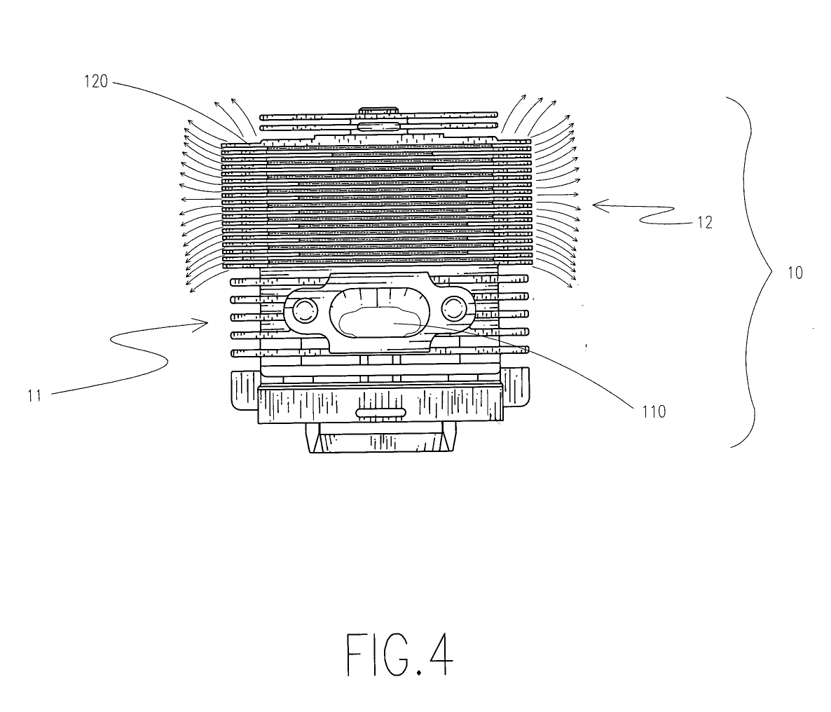

Referring to FIGS. 1 to 4, the heat dispensing device 12 for a cylinder 10 of the present invention comprises a plurality of horizontal fins 120 extending from the cylinder body 11. The cylinder body 11 includes an inlet (not shown) and an outlet 110. Each fin 120 has a first end horizontally extending from an outer surface of the cylinder body 11 and a second end of each of the fins 120 has a fork-shaped distal end 122. The fork-shaped distal end 122 of each fin 120 includes two protrusions in axial direction with a gap defined therebetween. The fins 120 can be straight plates and there are gaps defined between the fins 120 so that airflow can be smoothly passed through the gaps and bring heat from the fins 120. The fork-shaped distal ends 122 increase the area for removing the heat to the air and the efficiency of heat dispensing can be improved.

The fins 120 can be made the same length as the conventional straight fins, but the fork-shaped distal ends 122 provide more heat dispensing area than the conventional straight fins so as to improve the efficiency of heat dispensing.

While we have shown and described the embodiment in accordance with the present invention, it should be clear to those skilled in the art that further embodiments may be made without departing from the scope of the present invention.

What is claimed is:

1. A heat dispensing device for a cylinder which includes a cylinder body which has an outlet and an inlet, comprising:
a plurality of fins and each fin having a first end adapted to horizontally extending from an outer surface of the cylinder body, a second end of each of the fins having a fork-shaped distal end.

2. The device as claimed in claim 1, wherein the fork-shaped distal end of each fin includes two protrusions in axial direction and a gap is defined between the two protrusions.
